(19) United States
(12) Patent Application Publication
(10) Pub. No.: US 2003/0142240 A1
(43) Pub. Date: Jul. 31, 2003

(54) Device and method for interfacing digital video processing devices

(75) Inventor: Joseph Keith Masters, Mahopac, NY (US)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/059,442

(22) Filed: Jan. 29, 2002

(51) Int. Cl. H04N 9/64; H04N 7/04

(52) U.S. Cl. 348/720; 348/469

(57) ABSTRACT

A digital video interface device interfaces a digital video signal transmitted from a first, source, digital video processing device to a plurality of second digital video processing devices. The digital video interface device receives a digital video signal having a transition minimized differential signaling (TMDS) format, translates the received digital video signal to a second signaling format, buffers the translated digital video signal to produce a plurality of substantially identical buffered translated digital video signals, and translates each of the plurality of substantially identical buffered translated digital video signals back to the TMDS format. The digital video interface device includes a first translator receiving a TDMS digital video signal and translating the received TMDS signal to a second signaling format, a buffer receiving the translated digital video signal and outputting a buffered translated digital video signal, and a second translator translating the buffered translated digital video signal back to the TMDS format.

### BACKGROUND AND SUMMARY OF THE INVENTION

1) Field of the Invention

This invention pertains to the field of digital video processing, and more particularly, to a system and method for interfacing multiple digital video processing devices.

2) Description

All aspects of video signal generation, production, processing, editing, distribution and display are rapidly moving from analog systems to digital systems.

The “Digital Visual Interface (DVI)” specification, produced by the Digital Display Working Group (DDWG), defines a standard for a low cost high speed digital video connection between a digital video source, such as a computing device with a digital video card (e.g., a personal computer) and a relatively non-expensive display device (e.g., a monitor). The DVI standard is display technology independent and supports many video display standards, in addition to the broadcast television standards. Because DVI-compliant display monitors receive and display a high bandwidth (i.e., high data rate) digital video data signal, such monitors can provide a high quality video display suitable for a broadcast television studio, post-production facility, or video storage facility.

The “Digital Visual Interface (DVI)” specification is hereby incorporated herein by reference for all purposes as if fully set forth herein.

The primary intended use of the DVI standard is a connection from a single computer video card to a single display monitor. Accordingly, the DVI establishes a standard for a point-to-point digital video connection. As established in the DVI Specification, DVI uses transition minimized differential signaling (TMDS) for the base electrical interconnection. FIG. 1 shows a conceptual diagram of a DVI connection between a DVI-compliant video source device (e.g., a graphics controller) and a video processing device (e.g., a display controller) having a DVI-compliant receiver. The DVI connection comprises three TMDS video data channel connections, and one TMDS clock connection.

FIG. 2 is a conceptual diagram of a TMDS connection in accordance with the DVI specification. The characteristic impedance, Zₒ, and the termination resistance, R_{T}, must be matched and are each specified as 50 Ω. The TMDS receiver termination supply voltage, AV_{cc}, is specified as 3.3V. The nominal single-ended output voltage swing between positive and negative logic levels is 500 mV, implying a current value of 10 mA for the constant current source shown in the TMDS transmitter in FIG. 2.

The DVI interface specifically requires a DC-coupled TMDS connection. DVI Specification, paragraph 4.3.

Unfortunately, there is a problem with DVI connections between devices for many digital video applications. For example, in video post-production facilities and other applications, it is necessary to interface a digital video signal from one video source device to a plurality of digital video processing devices such as displays, format converters, video storage devices, etc. In other applications, it may be desirable to multiplex among several digital video source signals to be supplied selectively to several digital video processing devices. However, as mentioned above, DVI uses a point-to-point (one-to-one) interface. That is, a standard DVI connection does not support multi-point distribution or multiplexing of DVI-compliant signals to a plurality of DVI receivers.

Accordingly, it would be desirable to provide a device and method for interfacing a digital video signal transmitted from a source digital video processing device (e.g., a video display card) to a plurality of destination digital video processing devices (e.g., display monitors, format converters, etc.). It would also be desirable to provide a device and method for selectively multiplexing among a plurality of digital video signals for distribution to one or more digital video processing devices (e.g., display monitors, format converters, etc.). The present invention is directed to addressing one or more of the preceding concerns.

In one aspect of the invention, a method of interfacing a digital video signal to a plurality of digital video interface receivers comprises: receiving a digital video signal having a first, transition minimized differential signaling (TMDS), format; translating the received digital video signal to a second signaling format; buffering the translated digital video signal to produce a plurality of substantially identical buffered translated digital video signals; translating each of the plurality of substantially identical buffered translated digital video signals back to the TMDS format; and outputting the plurality of substantially identical digital video signals having the TMDS format to a corresponding plurality of digital video interface devices.

In another aspect of the invention, a digital video interface device comprises: a first translator adapted to receive a digital video signal having a first, transition minimized differential signaling (TMDS), format, to translate the received TMDS signal to a second signaling format, and to output a translated digital video signal; a buffer adapted to receive the translated digital video signal from the first translator and to output a buffered translated digital video signal; and a second translator adapted to receive the buffered translated digital video signal and to translate the buffered translated digital video signal back to the TMDS format..

In still another aspect of the invention, a digital video interface device comprises: a plurality of first translators each adapted to receive a digital video signal having a first, transition minimized differential signaling (TMDS), format, to translate the received TMDS signal to a second signaling format, and to output a translated digital video signal; a plurality of second translators adapted to receive one of the translated digital video signals and to translate the translated digital video signal back to the TMDS format; and means adapted to receive the translated digital video signals from the first translators and to selectively connect the translated digital video signals to the second translators.

### DESCRIPTION OF THE DRAWINGS

FIG. 1 shows a conceptual diagram of a digital video interface (DVI) standard connection.

FIG. 2 shows a conceptual diagram of a transition minimized differential pair (TMDS) connection.

FIG. 3 shows an embodiment of a digital video interface device.

FIG. 4 shows an embodiment of a first translator.

FIG. 5 shows an embodiment of a buffer.

FIG. 6 shows an embodiment of a second translator.

### DESCRIPTION OF THE PREFERRED EMBODIMENTS

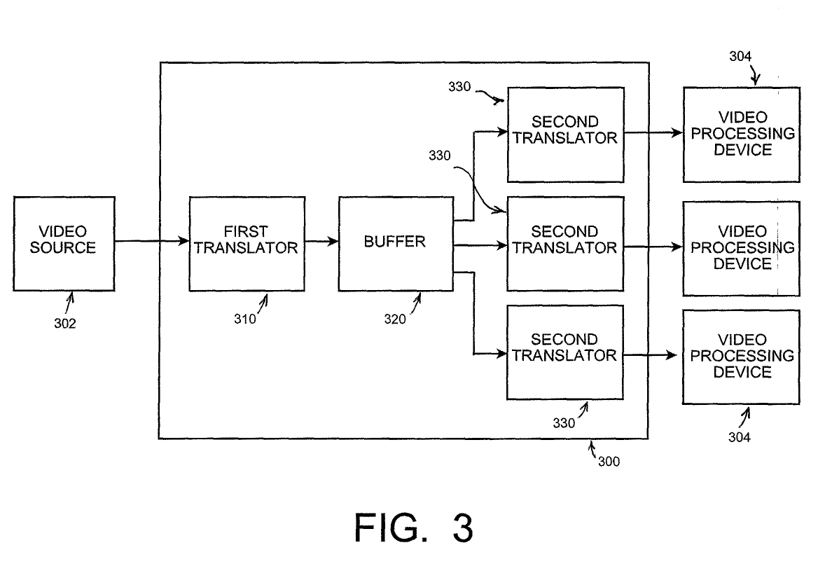

FIG. 3 shows a functional diagram of an embodiment of a digital video interface device 300. The digital video interface device 300 includes: a first translator 310 having an input receiving a digital video signal from a video source 302, and having an output; a buffer 320 having an input connected to the output of the first translator 310, and having one or more outputs; and one or more second translators 330 each having an input connected to one of the outputs of one of the buffer 320, and each having an output terminal providing the digital video signal to a video processing device 304.

An explanation of the operation of the digital video interface device 300 will now be provided. The digital video interface device 300 receives a digital video signal from a digital video interface transmitter of a video source 302 (e.g., a graphics controller), and provides the digital video signal to a plurality of digital video processing devices 304 (e.g., video displays, format converters, etc.) each having a digital video interface receiver. The first translator 310 receives a digital video signal having a first signaling format, beneficially a transition minimized digital signal (TMDS) format, and translates the digital video signal from the first signaling format to a second signaling format. Beneficially, there exists a wide variety of standard and relatively inexpensive off-the-shelf components available for processing a signal having the second signaling format.

Beneficially, the translator 310 receives a DVI-compliant TMDS digital video signal and translates the TMDS digital video signal to a +5 Volt positive emitter coupled logic (PECL) digital video signal. Such a PECL digital video signal is capable of being processed by standard PECL components, including, e.g., a PECL buffer.

The buffer 320 receives the translated digital video signal from the first translator 310 and outputs a plurality of buffered, translated digital video signals, each substantially the same as the received translated digital video signal. Each second translator 330 receives one of the buffered, translated digital video signals from the buffer 320 and translates the buffered, translated digital video signal back to the first signaling format, beneficially, TMDS. That is, the second translators 330 output digital video signals that are each substantially identical to the digital video signal received by the digital video interface device 300, and to each other.

Accordingly, the digital video interface device 300 receives a digital video signal having a first signaling format, beneficially TMDS, and outputs a plurality of substantially identical digital video signals each having the same signaling format as the received digital video signal.

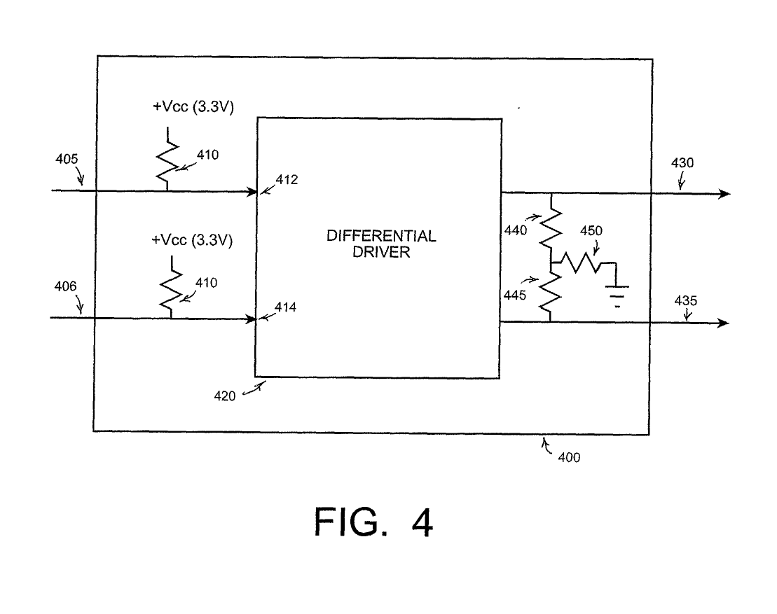

FIG. 4 shows an embodiment of a first translator 400, which may be the first translator 310 of FIG. 3. In the embodiment shown in FIG. 4, the first translator 400 translates a received TMDS digital video signal to a PECL signal. The first translator 400 receives a TMDS digital video signal at an input comprising a pair of lines 405, 406. Each line 405, 406 is pulled up to a supply voltage V_{cc} (3.3. Volts) via a 50 ohm resistor 410 and coupled to an input 412, 414 of a PECL differential driver 420. In one implementation, the PECL differential driver 420 may be an MC10EP17DT integrated circuit. The PECL differential driver 420 outputs therefrom a translated digital video signal in differential format on differential output lines 430 and 435. Each output line 430 and 435 of the translated digital video has the PECL signaling format. The translated PECL digital video signal on the differential output lines of the PECL differential driver 420 is properly terminated with resistors 440 and 445, each 50 ohms, and common termination resistor 450 having a resistance of 115 ohms to ground. Accordingly, the first translator 400 converts voltage levels of a received TMDS signal to predetermined levels (e.g., PECL levels), and outputs a translated digital video signal having the PECL signaling format.

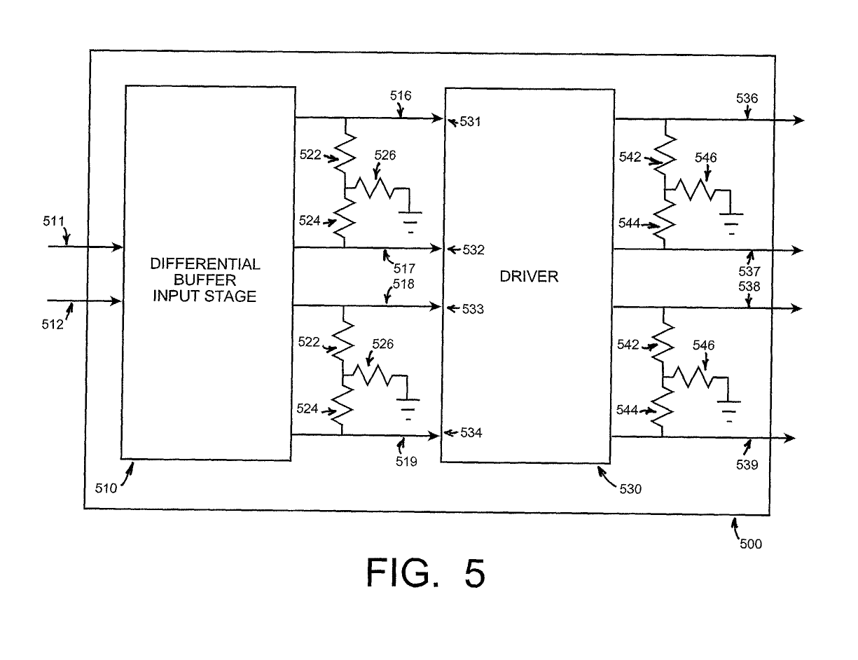

FIG. 5 shows an embodiment of a buffer 500, which may be the buffer 320 of FIG. 3. The buffer 500 includes a differential buffer input stage 510 receiving the translated digital video signal on a pair of input lines 511, 512, and outputting a plurality (e.g., two) of buffered, translated digital video signals. In one implementation, the differential buffer input stage 510 may be an MC10EP11DT integrated circuit. Although the described embodiment outputs two buffered, translated digital video signals, any number of buffered, translated digital video signals may be produced through a proper substitution of circuitry. Each of the buffered, translated digital video signals is output from the differential buffer input stage 510 on a pair of output lines 516, 517 and 518, 519, respectively. Each of the output line pairs, 516, 517 and 518, 519, is properly terminated for PECL signal levels using the resistors 522 and 524, each 50 ohms, and common termination resistor 526 having a resistance of 115 ohms to ground.

Each of the buffered, translated digital video signals is supplied from the differential buffer input stage 510 to a driver 530 on a pair of differential inputs 531, 532 and 533, 534, respectively. In one implementation, the driver 530 may be an MC10EP17DT integrated circuit. The driver 530 provides sufficient drive capability to drive the load of the subsequent second translator 330. Each of the buffered, translated digital video signals is output from the driver 530 on a pair of output lines 536, 537 and 538, 539, respectively. Each of the output line pairs, 536, 537 and 538, 539, is properly terminated for PECL signal levels using the resistors 542 and 544, each 50 ohms, and common termination resistor 546 having a resistance of 115 ohms to ground.

Beneficially, an individual supply voltage of the driver 530 for each pair of output lines 536, 537 and 538, 539 respectively may be controlled by a corresponding “hot plug detect” signal indicating whether or not a video processing device 304 is connected to the corresponding output of the digital video interface device 300. In that case, the driver circuitry for each output line pair is disabled whenever no video processing device 304 is connected to the corresponding output of the digital video interface device 300. However, once a video processing device 304 is connected to an output of the digital video interface device 300, then a voltage level appears on a corresponding “hot plug detect” line from the a video processing device 304 indicating the presence of a connected device. In response to the voltage level on the “hot plug detect” line, the supply voltage is supplied for the corresponding driver output circuitry. Beneficially, a plurality of light-emitting diodes may be supplied, each of which is turned on (or off) to indicate visually when a video processing device 304 is connected to a corresponding output of the digital video interface device 300.

Accordingly, the buffer 500 outputs a plurality of substantially identical buffered digital video signals, beneficially each having the PECL signaling format.

The second translator 330 receives a buffered, translated digital video signal from the buffer 320 and translates the buffered translated digital video signal back to the original signaling format, beneficially, a TMDS format. The TMDS digital video signal is compliant with digital video inputs for DVI-compliant digital video processing devices such as displays, format converters, etc. Accordingly, via the digital video interface device 300, an output of each second translator 330 may be connected to an input of a different digital video signal processing device, beneficially, a DVI-compliant digital display, DVI format converter, etc.

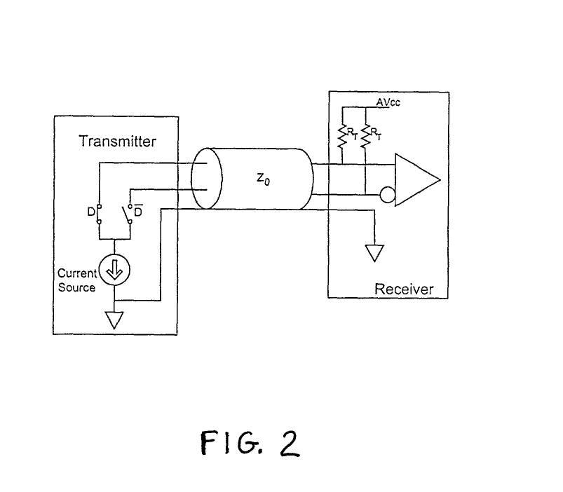

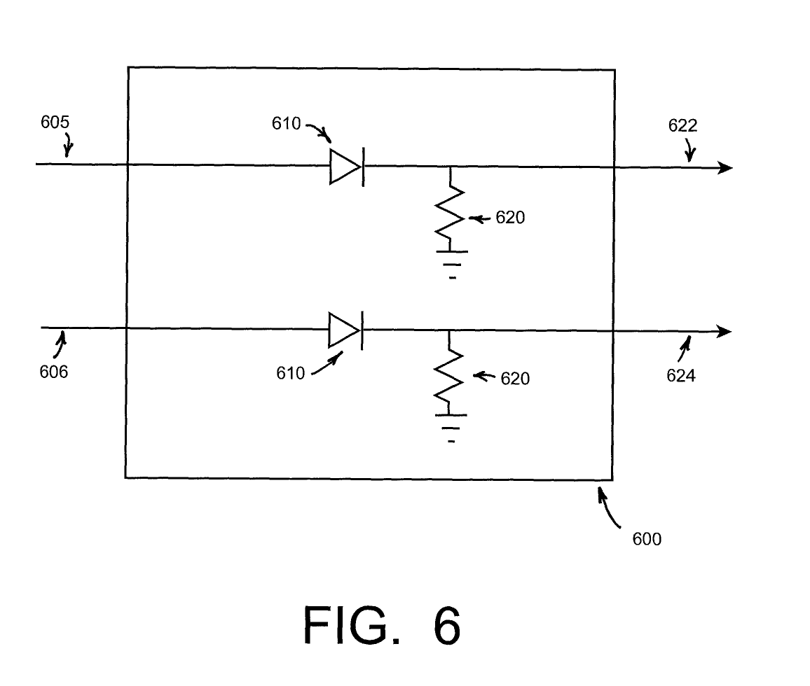

FIG. 6 shows an embodiment of a second translator 600, which may be the second translator 330 of FIG. 3. As noted above, the DVI standard specifically requires a DC-coupled TMDS connection. Significantly, this requirement is satisfied by the second translator 600 shown in FIG. 6. The second translator 600 receives a PECL digital video signal at an input comprising a pair of lines 605, 606. Each line 605, 606 is connected to the anode of a diode 610. Beneficially, the diode 610 has a nominal voltage drop of about 0.7 volts between the anode and cathode thereof. The cathode of each diode 610 is connected to a source resistor 620 having a nominal resistance of 412 ohms, the other end of which is grounded. The cathode of each diode 610 is also connected to an output line, 622 and 624 respectively, of the second translator 600. The digital video signal on the output lines 622, 624 has the proper TMDS signaling format and is capable of being connected to a TMDS receiver, such as that shown in FIG. 2, and properly driving the TMDS receiver. Accordingly, the second translator 600 differentially receives a PECL digital video signal and restores the voltage levels of the PECL digital video signal back to the TMDS format to output a DVI-compliant TMDS digital video signal.

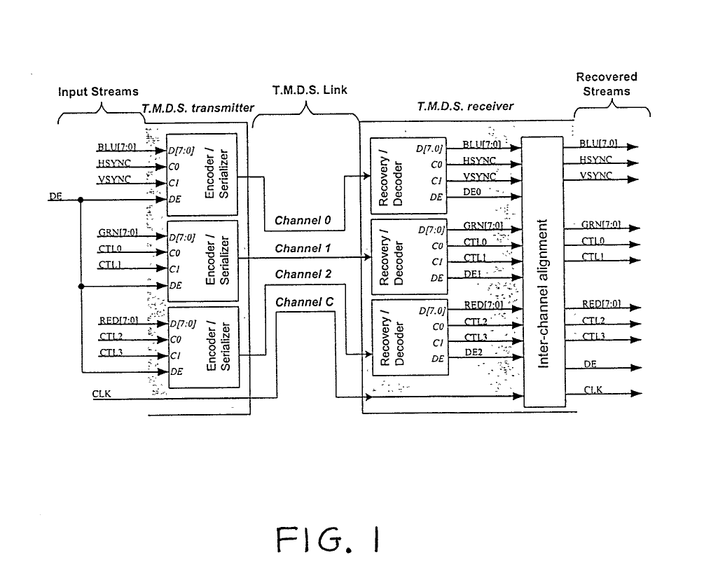

As described above, a plurality of substantially identical TMDS output signals may be produced from a single TMDS input signal. However, as shown in FIG. 1, a DVI connection, e.g., between a graphics controller and a display controller, comprises three (3) TMDS video data channel connections, and one (1) TMDS clock connection. Accordingly, in that case, for each DVI-compliant source signal, the digital video interface device 300 receives a total of four (4) TMDS input signals. In turn, for each of the four (4) TMDS input signals, the digital video interface device 300 produces a plurality of TMDS output signals each substantially identical to the corresponding TMDS input signal. Thus, for example, where the digital video interface device 300 receives one (1) DVI-compliant source signal and provides two (2) DVI-compliant output signals, the digital video interface device 300 receives a total of four (4) TMDS input signals and outputs a total of eight (8) TDMS output signals—two sets of four (4) TMDS signals, each set comprising one DVI-compliant output signal.

The circuitry in the digital video interface device 300 to interface a DVI-compliant source signal to multiple DVI-compliant video processing devices may be implemented in any combination of one or more integrated circuits.

As described above, the digital video interface device 300 may interface one DVI-compliant source signal to a plurality of DVI-compliant digital video processing devices. However, more generally, the digital video interface device 300 may have a plurality of inputs and outputs. Such a digital video interface device 300 may switch received digital video signals between and among output terminals to provide enhanced digital video signal processing flexibility. In that case, the digital video interface device 300 includes a plurality of first translators corresponding to the number of received digital video signals. The buffer 320 may be replaced by one or more multiplexers, switches, and/or demultiplexers, which may be one or more standard logic devices designed to operate on signals having the second signaling format (e.g., PECL devices), receiving the translated digital video signals. Control terminals may control the switching of the various translated digital video signals to one or more second translators 330 associated with the output terminals by means of the multiplexer(s), switch(es) and/or demultiplexer(s).

While preferred embodiments are disclosed herein, many variations are possible which remain within the concept and scope of the invention. For example, the preferred embodiment has been described with respect to a single-link DVI connection. However, a dual-link DVI connection may be supported by adding three additional TMDS connections, as indicated in FIG. 2-1 of the DVI Specification. Such variations would become clear to one of ordinary skill in the art after inspection of the specification, drawings and claims herein. The invention therefore is not to be restricted except within the spirit and scope of the appended claims.

What is claimed is:

1. A method of interfacing a digital video signal to a plurality of digital video interface receivers, the method comprising:
receiving a digital video signal having a first, transition minimized differential signaling (TMDS), format;
translating the received digital video signal to a second signaling format;
buffering the translated digital video signal to produce a plurality of substantially identical buffered translated digital video signals;
translating each of the plurality of substantially identical buffered translated digital video signals back to the TMDS format; and
outputting the plurality of substantially identical digital video signals having the TMDS format to a corresponding plurality of digital video interface devices.

2. The method of claim 1, wherein the second signal format is a positive emitter coupled logic (PECL) format.

3. The method of claim 1, wherein each of the plurality of substantially identical digital video signals having the TMDS format is DC-coupled.

4. A digital video interface device, comprising:
a first translator adapted to receive a digital video signal having a first, transition minimized differential signaling (TMDS), format, to translate the received TMDS signal to a second signaling format, and to output a translated digital video signal;
a buffer adapted to receive the translated digital video signal from the first translator and to output a buffered translated digital video signal; and
a second translator adapted to receive the buffered translated digital video signal and to translate the buffered translated digital video signal back to the TMDS format.

5. The digital video interface device of claim 4, wherein the buffer outputs a second buffered translated digital video signal, the digital video interface device further comprising an additional second translator adapted to receive the second buffered translated digital video signal and to translate the second buffered translated digital video signal back to the TMDS format.

6. The digital video interface device of claim 5, wherein the second signal format is a positive emitter coupled logic (PECL) format.

7. The digital video interface device of claim 4, wherein the second signal format is a positive emitter coupled logic (PECL) format.

8. The digital video interface device of claim 4, wherein an input and output of the second translator are DC-coupled.

9. The digital video interface device of claim 4, wherein the second translator has an input terminal and an output terminal and comprises:
a diode having an anode connected to the input terminal and a cathode connected to the output terminal; and
a resistor connected between the output terminal and ground.

10. The digital video interface device of claim 9, wherein the resistor has a resistance of about 412 ohms.

11. The digital video interface device of claim 4, wherein the first translator has at least two input terminals and at least two output terminals, and comprises:
a differential driver having a differential input coupled to the at least two input terminals and a differential output coupled to the at least two output terminals; and
a pair of pull-up resistors each connected between one of the input terminals and a power supply voltage.

12. The digital video interface device of claim 11, wherein each of the pull-up resistors has a resistance of about 50 ohms.

13. A digital video interface device, comprising:
a plurality of first translators each adapted to receive a digital video signal having a first, transition minimized differential signaling (TMDS), format, translate the received TMDS signal to a second signaling format, and output a translated digital video signal;
a plurality of second translators adapted to receive one of the translated digital video signals and to translate the translated digital video signal back to the TMDS format; and
means adapted to receive the translated digital video signals from the first translators and to selectively connect the translated digital video signals to the second translators.

14. The digital video interface device of claim 13, wherein the second signal format is a positive emitter coupled logic (PECL) format.

15. The digital video interface device of claim 13, wherein an input and output of each second translator are DC-coupled.

16. The digital video interface device of claim 13, wherein each second translator has an input terminal and an output terminal and comprises:
a diode having an anode coupled to the input terminal and a cathode coupled to the output terminal; and
a resistor connected between the output terminal and ground.

17. The digital video interface device of claim 16, wherein the resistor has a resistance of about 412 ohms.

18. The digital video interface device of claim 13, wherein each first translator has at least two input terminals and at least two output terminals, and comprises
a differential driver having a differential input coupled to the at least two input terminals and a differential output coupled to the at least two output terminals; and
a pair of pull-up resistors each connected between one of the input terminals and a power supply voltage.

19. The digital video interface device of claim 18, wherein each of the pull-up resistors has a resistance of about 50 ohms.
